(19) United States
(12) Patent Application Publication
(10) Pub. No.: US 2013/0080157 A1
(43) Pub. Date: Mar. 28, 2013

(54) CODING APPARATUS AND METHOD USING RESIDUAL BITS

(71) Applicants: Hyun-Woo KIM, Daejeon (KR); Do-Young KIM, Daejeon (KR); Byung-Sun LEE, Daejeon (KR)

(72) Inventors: Hyun-Woo KIM, Daejeon (KR); Do-Young KIM, Daejeon (KR); Byung-Sun LEE, Daejeon (KR)

(73) Assignee: Electronics and Telecommunications Reasearch Institute, Daejeon (KR)

(21) Appl. No.: 13/338,748

(22) Filed: Dec. 28, 2011

(30) Foreign Application Priority Data
Sep. 26, 2011 (KR) 10-2011-0096750

(51) Int. Cl. G10L 19/14

(52) U.S. Cl. 704/225; 704/E19.039

(57) ABSTRACT

Disclosed is a coding apparatus and method using residual bits. Accordingly, performance (voice quality) is enhanced by quantizing a full-band gain of frequency coefficients existing in sub-bands to which bits are not assigned in an algebraic vector quantization (AVQ). Further, the performance (voice quality) is enhanced by sequentially quantizing a sub-band gain of sub-bands to which bits are not assigned until residual bits are removed. Furthermore, the performance (voice quality) is enhanced by demodulating AVQ coefficients, and correcting quantization noises starting with a coefficient having the greatest absolute coefficient among the AVQ coefficients, when residual bits additionally remain.

### CROSS-REFERENCE TO RELATED APPLICATIONS

The present application claims priority of Korean Patent Application No. 10-2011-0096750, filed on Sep. 26, 2011, which is incorporated herein by reference in its entirety.

### BACKGROUND OF THE INVENTION

1. Field of the Invention

Exemplary embodiments of the present invention relate to a coding apparatus and method for enhancing voice quality by efficiently utilizing residual bits when voice/audio is modulated/demodulated using algebraic vector quantization (AVQ); and, more particularly, to a coding apparatus and method for enhancing voice quality by performing an AVQ operation on frequency coefficients converted from an input voice/audio signal, correcting gains of sub-bands to which bits are not assigned, and quantizing sub-bands to which bits are assigned.

Although a voice/audio codec using the AVQ is illustrated as an example in the following embodiments, the present invention is not limited thereto.

2. Description of Related Art

In general, many voice/audio codecs for compressing pulse code modulation (PCM) signals have been developed for the purpose of storage, transmission, reproduction, etc. Current voice/audio codecs use a method of converting an input signal from a time region to a frequency region and quantizing the converted signal.

However, in the conventional quantization methods, voice quality degradation occurs due to an inaccurate gain of sub-bands to which bits are not assigned, and therefore, performance (voice quality) is deteriorated.

### SUMMARY OF THE INVENTION

An embodiment of the present invention is directed to a coding apparatus and method for enhancing performance (voice quality) by efficiently utilizing residual bits when voice/audio is modulated/demodulated using AVQ.

Another embodiment of the present invention is directed to a coding apparatus and method for enhancing performance (voice quality) by quantizing a full-band gain of frequency coefficients existing in sub-bands to which bits are not assigned in an AVQ process.

Another embodiment of the present invention is directed to a coding apparatus and method, which enhances performance (voice quality) by quantizing a full-band gain of frequency coefficients existing in sub-bands to which bits are not assigned in an AVQ process, and further enhances the performance (voice quality) by sequentially quantizing a sub-band gain of sub-bands to which bits are not assigned until residual bits are removed.

Another embodiment of the present invention is directed to a coding apparatus and method, which enhances performance (voice quality) by quantizing a full-band gain of frequency coefficients existing in sub-bands to which bits are not assigned in an AVQ process, further enhances the performance (voice quality) by sequentially quantizing a sub-band gain of sub-bands to which bits are not assigned until residual bits are removed, and furthermore enhances the performance (voice quality) by demodulating AVQ coefficients, and correcting quantization noises starting with a coefficient having the greatest absolute coefficient among the AVQ coefficients, when residual bits additionally remain.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a coding apparatus includes an algebraic vector quantization (AVQ) performance means configured to receive frequency coefficients and perform an AVQ process on the received coefficients, and a first performance enhancement means configured to enhance performance by quantizing a full-band gain of frequency coefficients existing in sub-bands to which bits are not assigned in the AVQ process.

The coding apparatus may further include a second performance enhancement means configured to enhance performance by quantizing a gain of each sub-band to which bits are not assigned based on residual bits, when the residual bits remain after the quantization is performed by the first performance enhancement means.

The coding apparatus may further include a third performance enhancement means configured to enhance performance by correcting quantization noises starting with a coefficient having the greatest absolute value among frequency coefficients demodulated by performing an AVQ demodulation process when residual bits additionally remain after the quantization is performed on each of the sub-bands to which the bits are not assigned.

In accordance with another embodiment of the present invention, a coding method in a coding apparatus includes receiving frequency coefficients and performing an AVQ process, and enhancing performance by quantizing a full-band gain of frequency coefficients existing in sub-bands to which bits are not assigned in the AVQ process.

The coding method may further include enhancing performance by quantizing a gain of each sub-band to which bits are not assigned based on residual bits, when the residual bits remain after the quantization is performed in the enhancing of the performance.

The coding method may further include enhancing performance by correcting quantization noises starting with a coefficient having the greatest absolute value among frequency coefficients demodulated by performing an AVQ demodulation process when residual bits additionally remain after the quantization is performed on each of the sub-bands to which the bits are not assigned.

### BRIEF DESCRIPTION OF THE DRAWINGS

FIG. 1 is a configuration diagram illustrating an apparatus using residual bits (i.e., a coding apparatus using residual bits) in a voice/audio codec using an AVQ in accordance with an embodiment of the present invention.

FIG. 2 is a flowchart illustrating a method using residual bits (i.e., a coding method using residual bits) in the voice/audio codec using the AVQ in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

It will be understood that when an element is referred to as being “coupled” or “connected” to another element, it can be directly coupled or connected to the other element or intervening elements may also be present. It will be further understood that the terms “includes” and/or “including,” when used in this specification, specify the presence of stated elements and/or components, but do not preclude the presence and/or addition of one or more other elements and/or components thereof.

First, main technical points of the present invention will be briefly described as follows.

The voice/audio codecs use a method of converting an input signal from a time region to a frequency region and quantizing the converted signal. Representative quantization methods include a tree-structured quantization method, a product quantization method, a lattice quantization method, a predictive quantization method, an address quantization method, a fine-coarse quantization method, a multistage quantization method, a trellis-coded quantization method, a pyramid quantization method, and the like.

Among various quantization methods, an AVQ method based on Gosset lattice is used in a G.722/G.711.1 SWB codec, a G.718 codec, etc., and has excellent voice performance. The AVQ method based on the Gosset lattice is a method of dividing frequency coefficients converted from a voice/audio signal into a plurality of eight-dimensional sub-bands (or vectors) and quantizing the plurality of eight-dimensional sub-bands (or vectors) using bits based on a gain for each of the sub-bands. Here, the number of bits increases as the gain increases. In an AVQ method for extending a codebook based on Voronoi, bits are assigned to each sub-band as a multiple of five (0 bit, 5 bits, 10 bits, . . . ).

Generally, if an algebraic vector quantization (AVQ) process is performed on frequency coefficients converted from an input signal, residual bits may occur.

Thus, in the present invention, the residual bits are efficiently used by quantizing a gain of each sub-band to which bits are not assigned in the AVQ process, so that it is possible to enhance the voice quality of a voice/audio codec.

In other words, performance (voice) is enhanced by sequentially quantizing a full-band gain of frequency coefficients existing in sub-bands to which bits are not assigned in the QVA process and a gain of each of the sub-bands.

Further, if residual bits additionally remain, a more precise quantization process is performed using a method of correcting quantization noises starting with a coefficient having the greatest absolute coefficient among AVQ-demodulated coefficients.

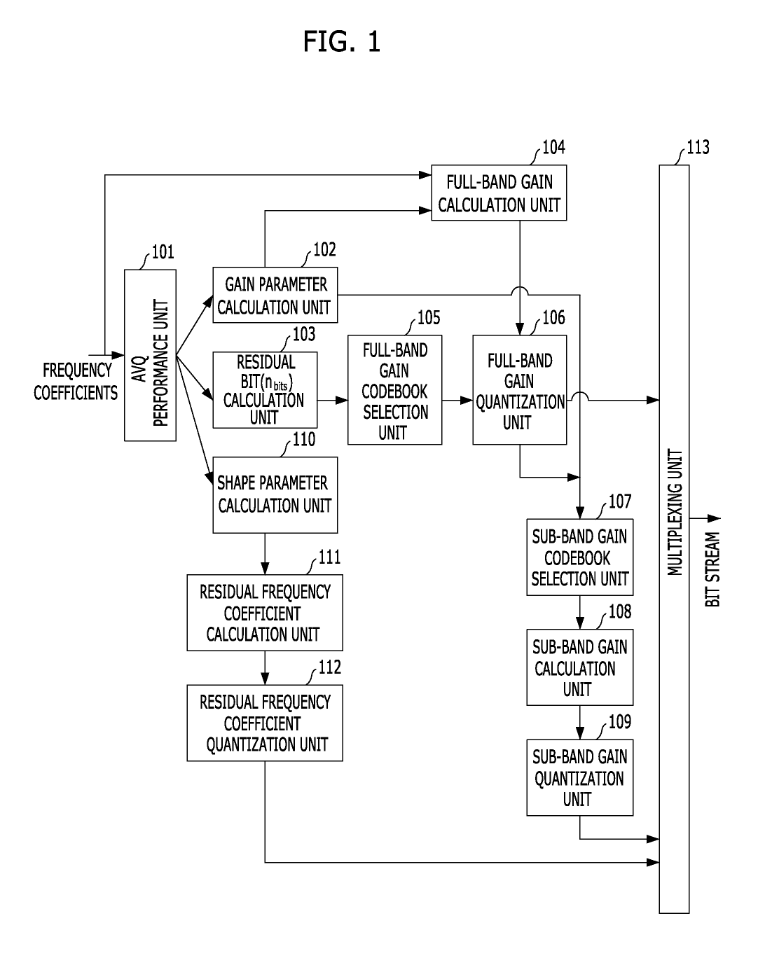

FIG. 1 is a configuration diagram illustrating an apparatus using residual bits (i.e., a coding apparatus using residual bits) in a voice/audio codec using an AVQ in accordance with an embodiment of the present invention.

As illustrated in FIG. 1, the coding apparatus in accordance with the embodiment of the present invention includes an AVQ performance unit 101, a gain parameter calculation unit 102, a residual bit calculation unit 103, a full-band gain calculation unit 104, a full-band gain codebook selection unit 105 and a full-band gain quantization unit 106. The AVQ performance unit 101 receives frequency coefficients converted from a voice/audio signal and performs an AVQ process on the received frequency coefficients. The gain parameter calculation unit 102 calculates the number (N) of sub-bands to which bits are not assigned in the AVQ process performed by the AVQ performance unit 101 and indices (iₙ) of the sub-bands. The residual bit calculation unit 103 calculates residual bits after the bits are assigned to the sub-bands in the AVQ process performed by the AVQ performance unit 101. The full-band gain calculation unit 104 calculates a full-band gain of frequency coefficients existing in the sub-bands to which the bits are not assigned. The full-band gain codebook selection unit 105 selects full-band gain codebooks based on the residual bits calculated by the residual bit calculation unit 103. The full-band gain quantization unit 106 quantizes the full-band gain calculated by the full-band gain calculation unit 104 using the full-band gain codebooks selected by the full-band gain codebook selection unit 105.

The coding apparatus further includes a sub-band gain codebook selection unit 107, a sub-band gain calculation unit 108 and a sub-band gain quantization unit 109. When residual bits remain after the full-band gain quantization unit 106 performs the quantization, the sub-band gain codebook selection unit 107 additionally selects sub-band gain codebooks based on the remaining residual bits existing in each of the unassigned sub-bands. The sub-band gain calculation unit 108 calculates sub-and gains of frequency coefficients existing in each of the sub-bands. The sub-band gain quantization unit 109 quantizes the sub-band gains calculated by the sub-band gain calculation unit 108 using the sub-band gain codebooks selected by the sub-band gain codebook selection unit 107.

The coding apparatus further includes a shape parameter calculation unit 110, a residual frequency coefficient calculation unit 111 and a residual frequency coefficient quantization unit 112. When residual bits additionally remain after the quantization process is performed on each of the sub-bands to which the bits are not assigned, the shape parameter calculation unit 110 demodulates AVQ coefficients quantized by the AVQ performance unit 101, arranges the demodulated AVQ coefficients in an order starting with a coefficient having the greatest absolute coefficient among the AVQ coefficients, and calculates positions of the AVQ coefficients. The residual frequency coefficient calculation unit 111 calculates residual frequency coefficients in the order starting with the coefficient having the greatest absolute coefficient among the coefficients demodulated by the shape parameter calculation unit 110. The residual frequency coefficient quantization unit 112 quantizes the residual frequency coefficients calculated by the residual frequency coefficient calculation unit 111.

Here, the coding apparatus may be implemented to further include a shape parameter calculation unit 110, a residual frequency coefficient calculation unit 111 and a residual frequency coefficient quantization unit 112. The shape parameter calculation unit 110 demodulates AVQ coefficients quantized by the AVQ performance unit 101, arranges the demodulated AVQ coefficients in an order starting with a coefficient having the greatest absolute coefficient among the AVQ coefficients, calculates positions of the AVQ coefficients, and stores the calculated positions of the AVQ coefficients. When residual bits additionally remain after the quantization process is performed on each of the sub-bands to which the bits are not assigned, the residual frequency coefficient calculation unit 111 calculates residual frequency coefficients in the order starting with the coefficient having the greatest absolute coefficient among the coefficients demodulated by the shape parameter calculation unit 110. The residual frequency coefficient quantization unit 112 quantizes the residual frequency coefficients calculated by the residual frequency coefficient calculation unit 111.

Next, the components described above will be described in detail as follows.

The AVQ performance unit 101 receives frequency coefficients converted from a voice/audio signal as inputs, and performs an existing AVQ process (quantization process). For example, in the G.722/G.711.1 SWB codec, the number of frequency coefficients is 64, and the number of eight-dimensional sub-bands is 8. The AVQ process is performed on first three sub-bands using 36 bits, and the AVQ process is performed on the next four sub-bands using 40 bits.

The gain parameter calculation unit 102 calculates the number (N) of sub-bands to which bits are not assigned in the AVQ process performed by the AVQ performance unit 101 and indices (iₙ) of the sub-bands. For example, if the AVQ process is performed on three or four sub-bands, bits are assigned based on a gain of each of the sub-bands. In this case, bits may not be assigned to a sub-band of which gain is small. As such, the total number of sub-bands to which bits are not assigned and to which sub-band the bits are not assigned are stored as indices.

The residual bit calculation unit 103 calculates residual bits after the bits are assigned to the sub-bands in the AVQ process performed by the AVQ performance unit 101. For example, since the bits are assigned as a multiple of five (0, 5, 10, 15, . . . ) in the AVQ process performed by the AVQ performance unit 101, residual bits may remain. If the gain of a specific band is extremely low, many bits may remain. For example, if the AVQ process is performed on first three sub-bands using 36 bits, 20 bits, 0 bit and 10 bits may be assigned to the three sub-bands, respectively. In this case, 6 bits remains as residual bits.

The full-band gain calculation unit 104 calculates a full-band gain of the frequency coefficients existing in the sub-bands to which the bits are not assigned, as illustrated in the following Expression 1. Here, the following Expression 1 is known in the art, and therefore, its detailed description will be omitted.

$${Gain}_{total} = sqrt ( \frac{1}{8 N} {\sum }_{k = 1}^{N} ( {\sum }_{j = 1}^{8} {MDCT ( 8 {i}_{k} + j )}^{2} ) ) \qquad Expression 1$$

Here, N denotes a number of sub-bands to which bits are not assigned.

The full-band gain codebook selection unit 105 selects full-band gain codebooks based on the residual bits calculated by the residual bit calculation unit 103. For example, three gain codebooks respectively corresponding to 1 bit, 2 bits and 3 bits may be used, and the codebooks are previously created using training data.

The full-band gain quantization unit 106 quantizes the full-band gain calculated by the full-band gain calculation unit 104 as the closest value in the full-band gain codebooks selected by the full-wave gain codebook selection unit 105.

When residual bits remain after the quantization is performed by the full-band gain quantization unit 106, the sub-band gain codebook selection unit 107 selects additionally selects sub-band gain codebooks based on the residual bits remaining in each of the sub-bands to which the bits are not assigned. Here, two sub-band gain codebooks respectively corresponding to 1 bit and 2 bits are previously created. The remaining residual bits may be obtained from the full-band gain quantization unit 106 or may be obtained from the full-band gain codebook selection unit 105.

The sub-band gain calculation unit 108 calculates a sub-band gain of the frequency coefficients existing in each of the sub-bands, as illustrated in the following Expression 2. Here, the following Expression 2 is known in the art, and therefore, its detailed description will be omitted.

$${Gain ( {i}_{k} )}_{local} = sqrt ( \frac{1}{8} {\sum }_{m = 1}^{8} {MDCT ( 8 {i}_{k} + m )}^{2} ) \qquad Expression 2$$

The sub-band gain quantization unit 109 quantizes the sub-band gain calculated by the sub-band gain calculation unit 108 as the closest value in the sub-band gain codebooks selected by the sub-band gain codebook selection unit 107.

The shape parameter calculation unit 110 demodulates AVQ coefficients quantized by the AVQ performance unit 101, arranges in an order starting with a coefficient having the greatest absolute coefficient among the AVQ coefficients, calculates positions of the AVQ coefficients, and stores the calculated positions. Alternatively, when residual bits additionally remain after the quantization is performed on each of the sub-bands to which the bits are not assigned, the shape parameter calculation unit 110 demodulates AVQ coefficients quantized by the AVQ performance unit 101, arranges in an order starting with a coefficient having the greatest absolute coefficient among the AVQ coefficients, and calculates positions of the AVQ coefficients.

When residual bits additionally remain after the quantization is performed on each of the sub-bands to which the bits are not assigned, the residual frequency coefficient calculation unit 111 calculates a difference between an input frequency coefficient and the coefficients demodulated by the shape parameter calculation unit 110 (i.e., a residual frequency coefficient). Alternatively, the residual frequency coefficient calculation unit 111 calculates differences between the coefficients demodulated by the shape parameter calculation unit 110 and an input frequency coefficient (i.e., a residual frequency coefficient).

The residual frequency coefficient quantization unit 112 quantizes the residual frequency coefficient calculated by the residual frequency coefficient calculation unit 111 as the closest value in the codebooks previously trained as two bits.

The multiplexing unit 113 outputs a corresponding bit stream by multiplexing output signals from the full-band gain quantization unit 106, the sub-band gain quantization unit 109 and the residual frequency coefficient quantization unit 112.

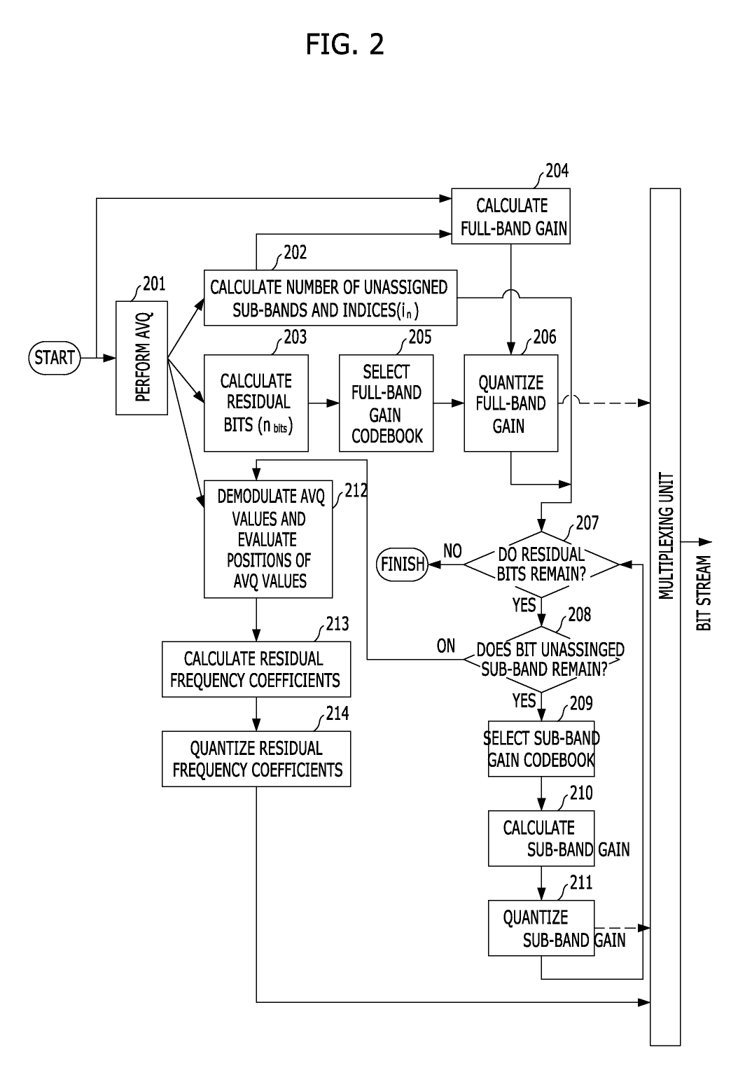

FIG. 2 is a flowchart illustrating a method using residual bits (i.e., a coding method using residual bits) in the voice/audio codec using the AVQ in accordance with the embodiment of the present invention. In FIG. 1, the embodiments of the present have been described in detail, and therefore, only main technical points of the coding method using residual bits will be briefly described below.

First, the AVQ performance unit 101 receives frequency coefficients converted from a voice/audio signal and performs an AVQ process on the received frequency coefficients (201).

The gain parameter calculation unit 102 calculates the number (N) of sub-bands to which bits are not assigned in the AVQ process and indices (iₙ) of the sub-bands (202).

The residual bit calculation unit 103 calculates residual bits after bits are assigned in the AVQ process (203).

The full-band gain calculation unit 104 calculates a full-band gain of the frequency coefficients existing in the sub-bands to which the bits are not assigned (204).

The full-band gain codebook selection unit 105 selects full-band gain codebooks based on the residual bits calculated by the residual bit calculation unit 103 (205).

The full-band gain quantization unit 106 quantizes the full-band gain calculated by the full-band gain calculation unit 104 using the full-band gain codebooks selected by the full-band gain codebook selection unit 105 (206).

Additionally, it is identified whether or not residual bits remain after the full-band gain quantization process (202 to 206) is performed (207). When the residual bits do not remain, the full-band gain quantization process is finished. When the residual bits remain, it is identified whether or not sub-bands to which bits are not assigned remain (208). When the sub-bands to which the bits are not assigned remain, the sub-band gain codebook selection unit 107 selects sub-band gain codebooks based on the residual bits remaining in each of the sub-bands to which the bits are not assigned (209).

The sub-band gain calculation unit 108 calculates a sub-band gain of frequency coefficients existing in each of the sub-bands (210).

The sub-band gain quantization unit 109 quantizes the sub-band gain calculated by the sub-band gain calculation unit 108 using the sub-band gain codebooks selected by the sub-band gain codebook selection unit 107 (211).

As the identified result (208), when the sub-bands to which the bits are not assigned do not remain, i.e., when residual bits additionally remain after the quantization is performed on each of the sub-bands to which the bits are not assigned, the shape parameter calculation unit 110 demodulates AVQ coefficients quantized by the AVQ performance unit 101, arranges the demodulated AVQ coefficients in an order starting with a coefficient having the greatest absolute coefficient among the AVQ coefficients, and calculates positions of the AVQ coefficients (212).

The residual frequency coefficient calculation unit 111 calculates residual frequency coefficients in the order starting with the coefficient having the greatest coefficient among the AVQ coefficients demodulated by the shape parameter calculation unit 110 (213).

The residual frequency coefficient quantization unit 112 quantizes the residual frequency coefficients calculated by the residual frequency coefficient calculation unit 111 (214).

Although not illustrated in this figure, the processes 212 to 214 may be implemented as follows.

First, the shape parameter calculation unit 110 demodulates AVQ coefficients quantized by the AVQ performance unit 101, arranges the demodulated AVQ coefficients in an order starting with a coefficient having the greatest absolute coefficient among the AVQ coefficients, calculates positions of the AVQ coefficients, and stores the calculated positions.

As the identified result (208), when sub-bands to which bits are not assigned do not remain, i.e., when residual bits additionally remain after the quantization is performed on each of the sub-bands to which the bits are not assigned, the residual frequency coefficient calculation unit 111 calculates residual frequency coefficients in the order starting with the coefficient having the greatest coefficient among the AVQ coefficients demodulated by the shape parameter calculation unit 110.

The residual frequency coefficient quantization unit 112 quantizes the residual frequency coefficients calculated by the residual frequency coefficient calculation unit 111.

In the conventional codec, voice quality degradation occurs due to an inaccurate gain of sub-bands to which bits are not assigned, and therefore, performance (voice quality) is deteriorated. However, in accordance with the exemplary embodiments of the present invention, voice quality can be enhanced by efficiently utilizing residual bits when voice/audio is modulated/demodulated using AVQ.

That is, noise caused due to an extremely estimated gain is removed by quantizing a full-band gain of frequency coefficients existing in sub-bands to which bits are not assigned in an AVQ process, so that it is possible to enhance performance (voice quality).

Further, noise caused due to an extremely estimated gain is removed by quantizing a full-band gain of frequency coefficients existing in sub-bands to which bits are not assigned in an AVQ process and sequentially quantizing a sub-band gain of frequency coefficients existing in the sub-bands to which the bits are not assigned until residual bits are removed, so that it is possible to enhance performance (voice quality).

Further, performance (voice quality) can be enhanced by quantizing a full-band gain of frequency coefficients existing in sub-bands to which bits are not assigned in an AVQ process, and the performance (voice quality) can be further enhanced by sequentially quantizing a sub-band gain of frequency coefficients existing in the sub-bands to which the bits are not assigned until residual bits are removed. The performance (voice quality) can be additionally enhanced by demodulating AVQ coefficients and correcting quantized noises starting with a coefficient having the greatest absolute coefficient among the demodulated AVQ coefficients, when residual bits additionally remain.

That is, since the full-band gain of frequency coefficients existing in the sub-bands to which the bits are not assigned and a gain of each of the sub-bands are obtained, performance (voice quality) can be enhanced by removing noise caused due to an extremely estimated gain. The performance (voice quality) can be further enhanced by demodulating existing AVQ parameters and then quantizing residual frequency coefficients, when residual bits additionally remain.

While the present invention has been described with respect to the specific embodiments, it will be apparent to those skilled in the art that various changes and modifications may be made without departing from the spirit and scope of the invention as defined in the following claims.

What is claimed is:

1. A coding apparatus, comprising:
an algebraic vector quantization (AVQ) performance means configured to receive frequency coefficients and perform an AVQ process on the received coefficients; and
a first performance enhancement means configured to enhance performance by quantizing a full-band gain of frequency coefficients existing in sub-bands to which bits are not assigned in the AVQ process.

2. The coding apparatus of claim 1, wherein the first performance enhancement means comprises:
a gain parameter calculation unit configured to calculate a number of the sub-bands to which the bits are not assigned in the AVQ process and indices of the sub-bands;
a residual bit calculation unit configured to calculate residual bits after bits are assigned in the AVQ process;
a full-band gain calculation unit configured to calculate a full-band gain of the frequency coefficients existing in the sub-bands to which the bits are not assigned;
a full-band gain codebook selection unit configured to select full-band gain codebooks based on the residual bits calculated by the residual bit calculation unit; and
a full-band gain quantization unit configured to quantize the full-band gain calculated by the full-band gain calculation unit using the full-band gain codebooks selected by the full-band gain codebook selection unit.

3. The coding apparatus of claim 1, further comprising a second performance enhancement means configured to enhance performance by quantizing a gain of each sub-band to which bits are not assigned based on residual bits, when the residual bits remain after the quantization is performed by the first performance enhancement means.

4. The coding apparatus of claim 3, wherein the second performance enhancement means comprises:
a sub-band gain codebook selection unit configured to select sub-band gain codebooks based on residual bits in each of the sub-bands to which the bits are not assigned, when the residual bits remain after the quantization is performed by the first performance enhancement means;
a sub-band gain calculation unit configured to calculate a sub-band gain of frequency coefficients existing in each of the sub-bands; and
a sub-band gain quantization unit configured to quantize the sub-band gain calculated by the sub-band gain calculation unit using the sub-band gain codebooks selected by the sub-band gain codebook selection unit.

5. The coding apparatus of claim 4, further comprising a third performance enhancement means configured to enhance performance by correcting quantization noises starting with a coefficient having the greatest absolute value among frequency coefficients demodulated by performing an AVQ demodulation process when residual bits additionally remain after the quantization is performed on each of the sub-bands to which the bits are not assigned.

6. The coding apparatus of claim 5, wherein the third performance enhancement means comprises:
a shape parameter calculation unit configured to demodulate AVQ coefficients quantized by the AVQ performance means, arrange the demodulated AVQ coefficients in an order starting with a coefficient having the greatest absolute coefficient among the AVQ coefficients, and calculate positions of the AVQ coefficients, when residual bits additionally remain after the quantization is performed on each of the sub-bands to which the bits are not assigned;
a residual frequency coefficient calculation unit configured to calculate residual frequency coefficients in the order starting with the coefficient having the greatest absolute coefficient among the AVQ coefficients demodulated by the shape parameter calculation unit; and
a residual frequency coefficient quantization unit configured to quantize the residual frequency coefficients calculated by the residual frequency coefficient calculation unit.

7. The coding apparatus of claim 5, wherein the third performance enhancement means comprises:
a shape parameter calculation unit configured to demodulate AVQ coefficients quantized by the AVQ performance means, arrange the demodulated AVQ coefficients in an order starting with a coefficient having the greatest absolute coefficient among the AVQ coefficients, calculate positions of the AVQ coefficients, and store the calculated positions;
a residual frequency coefficient calculation unit configured to calculate residual frequency coefficients in the order starting with a coefficient having the greatest absolute coefficient among the AVQ coefficients demodulated by the shape parameter calculation unit, when residual bits additionally remain after the quantization is performed on each of the sub-bands to which the bits are not assigned; and
a residual frequency coefficient quantization unit configured to quantize the residual frequency coefficients calculated by the residual frequency coefficient calculation unit.

8. A coding method in a coding apparatus, comprising:
receiving frequency coefficients and performing an AVQ process; and
enhancing performance by quantizing a full-band gain of frequency coefficients existing in sub-bands to which bits are not assigned in the AVQ process.

9. The coding method of claim 8, wherein said enhancing of the performance comprises:
calculating a number of the sub-bands to which the bits are not assigned in the AVQ process and indices of the sub-bands;
calculating residual bits after bits are assigned in the AVQ process;
calculating a full-band gain of the frequency coefficients existing in the sub-bands to which the bits are not assigned;
selecting full-band gain codebooks based on the calculated residual bits; and
quantizing the calculated full-band gain using the selected full-band gain codebooks.

10. The coding method of claim 8, further comprising enhancing performance by quantizing a gain of each sub-band to which bits are not assigned based on residual bits, when the residual bits remain after the quantization is performed in said enhancing of the performance.

11. The coding method of claim 10, wherein said enhancing of the performance comprises:
selecting sub-band gain codebooks based on residual bits in each of the sub-bands to which the bits are not assigned, when the residual bits remain after the quantization is performed in said enhancing of the performance;
calculating a sub-band gain of frequency coefficients existing in each of the sub-bands; and
quantizing the calculated sub-band gain using the selected sub-band gain codebooks.

12. The coding method of claim 10, further comprising enhancing performance by correcting quantization noises starting with a coefficient having the greatest absolute value among frequency coefficients demodulated by performing an AVQ demodulation process when residual bits additionally remain after the quantization is performed on each of the sub-bands to which the bits are not assigned.

13. The coding method of claim 12, wherein said enhancing of the performance comprises:
demodulating AVQ coefficients quantized in said performing of the AVQ process, arranging the demodulated AVQ coefficients in an order starting with a coefficient having the greatest absolute coefficient among the AVQ coefficients, and calculating positions of the AVQ coefficients, when residual bits additionally remain after the quantization is performed on each of the sub-bands to which the bits are not assigned;
calculating residual frequency coefficients in the order starting with the coefficient having the greatest absolute coefficient among the demodulated AVQ coefficients; and
quantizing the calculated residual frequency coefficients.

14. The coding method of claim 12, wherein said enhancing of the performance comprises:
demodulating AVQ coefficients quantized in said performing of the AVQ process, arranging the demodulated AVQ coefficients in an order starting with a coefficient having the greatest absolute coefficient among the AVQ coefficients, calculating positions of the AVQ coefficients, and storing the calculated positions;
calculating residual frequency coefficients in the order starting with a coefficient having the greatest absolute coefficient among the demodulated AVQ coefficients, when residual bits additionally remain after the quantization is performed on each of the sub-bands to which the bits are not assigned; and
quantizing the calculated residual frequency coefficients.
